(19) United States
(12) Patent Application Publication
(10) Pub. No.: US 2003/0235513 A1
(43) Pub. Date: Dec. 25, 2003

(54) Optical oxygen concentration measurement method and optical oxygen concentration measuring sensor

(75) Inventors: Keisuke Asai, Tokyo (JP); Hiroyuki Nishide, Tokyo (JP); Ichiro Okura, Yokohama-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: NATIONAL AEROSPACE LABORATORY OF JAPAN, Tokyo (JP)

(21) Appl. No.: 10/459,468

(22) Filed: Jun. 12, 2003

(30) Foreign Application Priority Data
Jun. 21, 2002 (JP) 2002-182244

(51) Int. Cl. G01N 21/00

(52) U.S. Cl. 422/56; 422/82.05

(57) ABSTRACT

The present invention provides an optical oxygen concentration measurement method and optical oxygen concentration measuring sensor wherein a light-absorbing dye-molecule layer whose absorption spectrum varies depending on the bonding with oxygen molecules is combined with a light-emitting layer, and the oxygen concentration of the ambient fluid can be measured. The light-absorbing layer 4 laminated to an oxygen-quenching light-emitting layer 3 is a film comprising a cobalt-porphyrin complex (CoP) or other light-absorbing dye molecule 7 whose absorption spectrum varies depending on the bonding with oxygen molecules. When the degree of overlap with the light emission spectrum or excitation (absorption) spectrum of the light-emitting layer 3 varies as a result of a variation in the absorption spectrum possessed by the light-absorbing layer 4, the light intensity of output light varies in accordance with the degree of overlap, and the oxygen concentration of the ambient fluid can be measured. These measurement method and measuring sensor can be applied not only to optical fiber sensors, but also to wind tunnel experiments and the like as pressure-sensitive paints.

### BACKGROUND OF THE INVENTION

1. Field of the Invention

The present invention relates to an optical oxygen concentration measurement method and optical oxygen concentration measuring sensor capable of optically detecting an oxygen concentration with high sensitivity by detecting output light whose light intensity varies in accordance with the oxygen concentration.

2. Description of the Related Art

In conventional practice, the luminescent or fluorescent sensors known as optical oxygen sensors are those in which pyrene derivatives, ruthenium complexes, platinum porphyrins, or other dye molecules having oxygen quenching characteristics are dispersed in polydimethylsiloxane, polystyrene, and other oxygen-transmitting resins. In these sensors, a reaction between the oxygen molecules and oxygen-quenching dye molecules depends on the diffusion of oxygen in the resin, making these sensors incapable of detecting oxygen with high sensitivity, which is an inherent quality of the dye molecules.

For this reason, the inventors have proposed a method (Japanese Patent Application Laid-open No. H11-37944) for directly adsorbing and supporting oxygen quenching dye molecules on anodized porous membranes formed on an aluminum surface, instead of dispersing the dye molecules in polymers as a method for improving the detection sensitivity of such oxygen sensors. A proposal has also been made (Japanese Patent Application Laid-open No. 2000-249076) concerning a high-sensitivity oxygen sensor in which poly[1-(trimethylsilyl)-1-propyne] (referred to hereinbelow as “poly(TMPS)”), which is a porous macromolecular material, is used as the transmitting resins for the oxygen quenching dye molecules. These proposals seek to improve oxygen sensitivity by the use of materials with high oxygen permeability as the media for dispersing the oxygen quenching dye molecules, and it has been confirmed that oxygen sensors fabricated using these methods have high oxygen sensitivity, undergo only a small reduction in sensitivity at low temperatures, and possess other excellent characteristics as oxygen sensors.

However, even when materials with such high oxygen permeability are used, the upper limit of sensitivity for an oxygen sensor is still determined by the physical properties, that is, the oxygen quenching rate, of the dye molecules, which is the sensitive element. For this reason, conventional optical oxygen sensors that utilize oxygen quenching are disadvantageous in that it is impossible to obtain adequate measurement sensitivity in regions with a comparatively high oxygen pressure.

In view of this, oxygen concentration could be measured according to a new detecting method if it were possible for the light transmission of a light-emitting layer, that is, for some of the light transmitted by the light-emitting layer or the incident light received in order to initiate light emission in the light-emitting layer, to be absorbed by an absorption layer whose light absorption spectrum varies depending on the degree of bonding with oxygen molecules, and for the degree of this absorption to be detected. Oxygen concentration could also be detected with an even higher detection sensitivity if it were possible to create a combination of an absorption layer and a light-emitting layer comprising dye molecule that has oxygen quenching characteristics.

### SUMMARY OF THE INVENTION

An object of the present invention is to provide a novel method for detecting an oxygen concentration by detecting output light whose light intensity varies in accordance with the oxygen concentration, and to provide an optical oxygen concentration measurement method and optical oxygen concentration measuring sensor whose oxygen sensitivity can be improved over that of a conventional optical oxygen sensor based solely on oxygen quenching, by combining an absorption layer and a light-emitting layer comprising a dye molecule that has oxygen quenching characteristics.

The optical oxygen concentration measurement method according to the present invention comprises using a combination of a light-emitting layer for receiving excitation light and emitting light, and a light-absorbing layer whose light absorption spectrum varies depending on the degree of bonding with oxygen molecules, which varies in accordance with the oxygen concentration; and further comprises measuring the oxygen concentration by detecting the light intensity of output light that varies based on the partial absorption of light emitted by the light-emitting layer, or incident light for initiating light emission in the light-emitting layer, during passage through the light-absorbing layer.

The optical oxygen concentration measuring sensor relating to the present invention comprises a light-emitting layer for receiving excitation light and emitting light, and a light-absorbing layer whose light absorption spectrum varies depending on the degree of bonding with oxygen molecules, which varies in accordance with the oxygen concentration; and further comprises creating variations in the light intensity of output light on the basis of partial absorption when light emitted by the light-emitting layer, or incident light for initiating light emission in the light-emitting layer, passes through the light-absorbing layer.

In accordance with the optical oxygen concentration measurement method and optical oxygen concentration measuring sensor relating to the present invention, the light-absorbing layer is a layer comprising dye molecules whose light absorption spectrum varies depending on the degree of bonding with oxygen molecules, which varies in accordance with the oxygen concentration, so part of the light emitted when the light-emitting layer emits light, or the incident light that serves as excitation light for initiating light emission in the light-emitting layer, is absorbed by the light-absorbing layer when the incident light or emitted light passes through the light-absorbing layer, and variations occur in the intensity of light that has passed through the light-absorbing layer. As a result, detecting of the oxygen concentration that corresponds to the degree of absorption by the light-absorbing layer, that is, the degree of bonding with oxygen molecules that causes variations in the light absorption spectrum, can be accomplished by detecting the light intensity of observed output light. Variations in the shape of a spectral distribution, a movement of the spectral distribution range, and the like can be cited as examples of variations in light absorption spectra, and the overlap with a light emission spectrum or an excitation spectrum related to the emission of light by a light-emitting layer varies with the shape variations or range movements of the spectral distribution, depending on the degree of bonding with oxygen molecules. The above process remains in effect and exhibits sensitivity with respect to oxygen concentration even in cases in which the light-emitting layer does not have any reactivity toward oxygen at all.

In the optical oxygen concentration measurement method and optical oxygen concentration measuring sensor relating to the present invention, the light partially absorbed by the light-absorbing layer is designated as incident light for initiating light emission in the light-emitting layer, the output light is designated as light emitted by the light-emitting layer, and the overlap of the excitation spectrum of the light-emitting layer and the light absorption spectrum can be caused to vary in accordance with variations in the light absorption spectrum. Specifically, the overlap of the light absorption spectrum of the light-absorbing layer and the excitation spectrum of the light-emitting layer varies when the light absorption spectrum of the light-absorbing layer varies depending on the degree of bonding with oxygen molecules that corresponds to the oxygen concentration, so the light intensity of excitation light for initiating light emission in the light-emitting layer after passing through the light-absorbing layer varies in accordance with the degree to which the two spectra overlap each other. As a result, variations occur in the light intensity of light emitted by the light-emitting layer, and the light intensity of observed output light varies as well, making it possible to measure the oxygen concentration by detecting the light intensity of this output light.

In the optical oxygen concentration measurement method and optical oxygen concentration measuring sensor relating to the present invention, the light partially absorbed by the light-absorbing layer is designated as light emitted by the light-emitting layer, the output light is designated as light transmitted through the light-absorbing layer, and the overlap of the light emission spectrum of the light-emitting layer and the light absorption spectrum can be caused to vary in accordance with variations in the light absorption spectrum. Specifically, the overlap of the light absorption spectrum of the light-absorbing layer and the excitation spectrum of the light-emitting layer varies when the light absorption spectrum of the light-absorbing layer varies depending on the degree of bonding with oxygen molecules that corresponds to the oxygen concentration, so the degree to which the output light of the light-emitting layer is absorbed by the light-absorbing layer varies in accordance with the degree to which the two spectra overlap each other. As a result, variations occur in the light intensity of output light transmitted through the light-absorbing layer, making it possible to measure oxygen concentration by detecting the light intensity of this output light. In the light absorption spectrum of the light-absorbing layer, variations can occur toward an increased or reduced overlap with the excitation spectrum or light emission spectrum as the degree of bonding with oxygen molecules increases. Specifically, light intensity decreases with increased oxygen concentration in the same manner as in the prior art when the light absorption spectrum of the light-absorbing layer changes in the direction of increased overlap with the light emission spectrum or excitation spectrum of the light-emitting layer as the degree of bonding with oxygen molecules increases. At this point, it is possible to construct a sensor suitable for measuring low oxygen concentrations. On the other hand, contrary to the above case, light intensity increases with increased oxygen concentration when the light absorption spectrum changes in the direction of reduced overlap with the light emission spectrum or excitation spectrum of the light-emitting layer. At this point, it is possible to construct a sensor suitable for measuring high oxygen concentrations.

In the optical oxygen concentration measurement method and optical oxygen concentration measuring sensor relating to the present invention, the light-emitting layer can be fashioned into a layer in which the light intensity of emitted light is varied by a reaction with oxygen molecules, which varies in accordance with oxygen concentration. By fashioning the light-emitting layer into a layer in which the light intensity of emitted light varies in accordance with the oxygen concentration, it is possible to enhance variations in the light intensity of output light in accordance with the oxygen concentration and to increase oxygen sensitivity by synergy with the absorption of light based on the light absorption spectrum of the light-absorbing layer. The light-emitting layer is preferably fashioned into an oxygen-quenching dye-molecule layer in which the light intensity of emitted light is lowered by the reaction with oxygen molecules.

In the optical oxygen concentration measurement method and optical oxygen concentration measuring sensor relating to the present invention, the light-absorbing layer may be fashioned into a layer that comprises a cobalt-porphyrin complex as the light-absorbing dye molecules. A cobalt picket-fence porphyrin complex (“CoP” hereinbelow) can be cited as an example of a cobalt-porphyrin complex that can be used for the light-absorbing layer needed to achieve the sensitization effect. The center wavelength of the absorption spectrum (Soret band) of CoP is moved from 418 nm to 440 nm by the bonding of oxygen. When the light-absorbing layer and light-emitting layer are fashioned into a laminated or layered structure, and the light-emitting dye molecules has oxygen quenching characteristics, oxygen transport occurs in the CoP layer as well, the reduction in emission intensity becomes pronounced in the region of low oxygen pressures, and the effect of improved detection sensitivity can be anticipated.

The optical oxygen concentration measurement method and optical oxygen concentration measuring sensor relating to the present invention can be applied to measuring the oxygen concentration of a gas or liquid that comprises oxygen molecules, or the pressure of a gas that comprises oxygen molecules. In the case of a gas, determining the oxygen concentration will make it possible to determine oxygen partial pressure, and to determine the static pressure of the gas if the mole ratio of the oxygen in the gas is known.

### BRIEF DESCRIPTION OF THE DRAWINGS

FIG. 1 is a principle diagram depicting the structure of the optical oxygen concentration measuring sensor relating to the present invention;

FIG. 2 is an explanatory drawing depicting the principle of oxygen measurement relating to the present invention;

FIG. 3 is a structural formula depicting an example of a cobalt picket-fence porphyrin complex as a dye molecule used in a light-absorbing layer;

FIG. 4 is a diagram depicting the spectroscopic properties of the cobalt picket-fence porphyrin complex shown in FIG. 3;

FIG. 5 is a diagram depicting the results of measuring light emission spectra in mixed dye-molecule solutions as specific examples of a sensitization effect (solution systems);

FIG. 6 is a diagram depicting variations in emission intensity of the mixed dye-molecule solutions according to oxygen concentration as a specific example of a sensitization effect; and

FIG. 7 is a diagram depicting variations in emission intensity of the solid films comprising dye-molecule layers according to oxygen concentration as a specific example of a sensitization effect (solid system).

### DESCRIPTION OF THE PREFERRED EMBODIMENTS

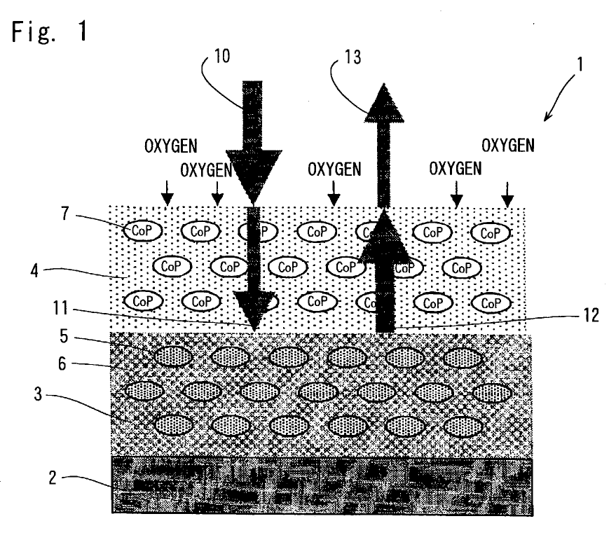

FIG. 1 is a schematic cross-sectional view depicting the principle of the optical oxygen concentration measuring sensor according to the present invention. The optical oxygen concentration measuring sensor (abbreviated as “sensor” hereinbelow) 1 comprises a light-emitting layer 3 provided to a substrate 2, and a light-absorbing layer 4 overlaid on the light-emitting layer 3. The light-emitting layer 3 is a light-emitting layer formed by dispersing a pyrene derivative, ruthenium complex, platinum porphyrin, or other dye molecule 5 with oxygen quenching characteristics in polydimethylsiloxane, polystyrene, or other oxygen-permeable resin 6 in the same manner as with a conventional optical oxygen sensor. The light-absorbing layer 4 is a layer formed by dispersing a light-absorbing dye-molecule 7 comprising the below-described cobalt picket-fence porphyrin complex (CoP) or the like; in the dye molecule 7, the light absorption spectrum can be varied depending on the bonding with oxygen molecules.

If there is a range in which the spectrum of light 10 incident on the sensor 1 and the light absorption spectrum of the light-absorbing layer 4 overlap each other, then the spectral portion of this range is absorbed by the light-absorbing layer 4 as pertains to incident light 10. There is, therefore, a reduction in the light intensity of excitation light 11, which initiates light emission (excites) in the light-emitting layer 3, and then there is a reduction in the intensity of emitted light 12, which is emitted by the light-emitting layer 3. Similarly, if there is a range in which the light emission spectrum of light 12 emitted by the light-emitting layer 3 and the absorption spectrum of the light-absorbing layer 4 overlap each other, then the spectral portion of this range is absorbed by the light-absorbing layer 4, and the intensity of output light 13 exiting the light-absorbing layer 4 decreases, as pertains to emitted light 12. A proportional relation exists in an equilibrium state between the degree of bonding that the dye molecules 5 and 7 have with oxygen molecules permeating the light-emitting layer 3 or light-absorbing layer 4, and the oxygen concentration (partial pressure) of the external medium (the atmosphere in the case of a gas) from which oxygen molecules are fed into the layers, so the oxygen concentration of the external medium can be measured by detecting the reduction in the intensity of output light 13.

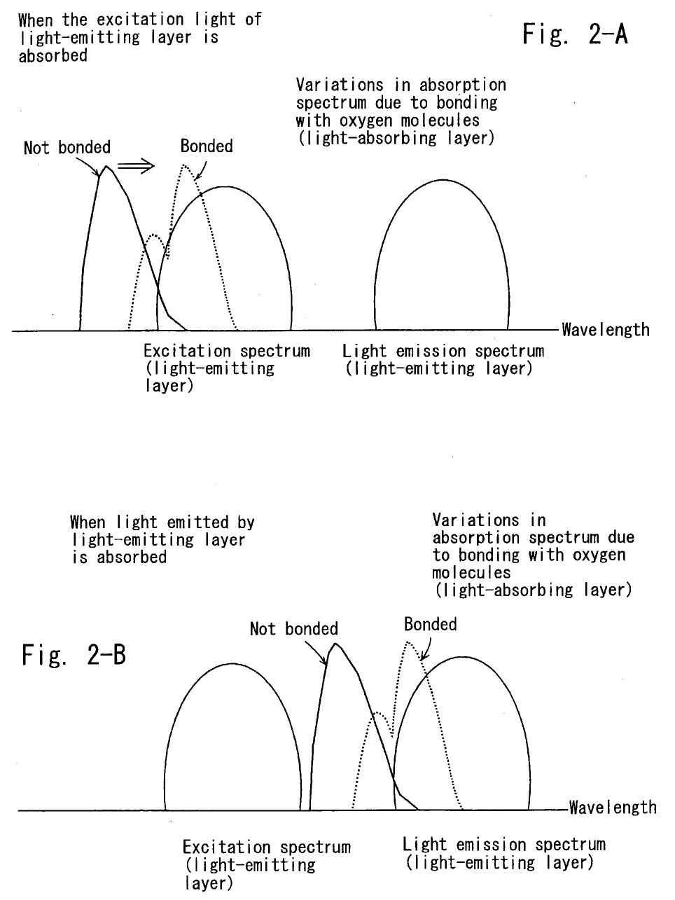

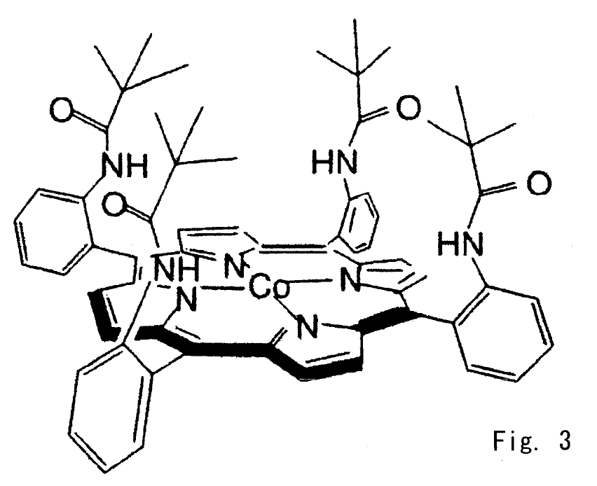

FIG. 2 is a diagram illustrating the principle of an oxygen measurement in a spectral band. When the light absorption spectrum of the light-absorbing layer 4 varies with the degree of bonding with oxygen molecules that corresponds to the oxygen concentration, the range in which the light absorption spectrum of the light-absorbing layer 4 and the excitation spectrum of the light-emitting layer 3 overlap each other varies within a corresponding wavelength band. When, for example, the absorption spectrum of the light-absorbing layer 4 bonded with oxygen molecules shifts toward longer wavelengths and overlaps on the excitation spectrum of the light-emitting layer 3, as shown in FIG. 2-A, part of the incident light for initiating light emission in the light-emitting layer 3 is absorbed, and there is a decrease in the light intensity of excitation light 11 that has passed through the light-absorbing layer 4. The actual variations in the absorption spectrum include variations in the shape of spectral distributions in addition to the shift toward longer wavelengths. As a result, variations occur in the light intensity of the light 12 emitted by the light-emitting layer 3, and then in the light intensity of output light 13. Since the extent of variations in the light intensity of output light 13 differs with the degree of bonding with oxygen molecules, the oxygen concentration can be measured by detecting the light intensity of output light 13. Similarly, when there is a variation in the range in which a overlap exists between the light absorption spectrum of the light-absorbing layer 4 and the light emission spectrum of light 12 emitted by the light-emitting layer 3 and transmitted by the light-absorbing layer 4, the absorption spectrum of the light-absorbing layer 4 bonded with oxygen molecules shifts toward longer wavelengths and overlaps on the light-emitting waveband of the light-emitting layer 3, and the light intensity of output light 13 is reduced by a process in which the light 12 emitted by the light-emitting layer 3 is partially absorbed by the light-absorbing layer 4, as shown, for example, in FIG. 2-B. In the same manner as in the case shown in FIG. 2-A, the actual variations in the absorption spectrum include variations in the shape of spectral distributions in addition to the shift toward longer wavelengths. Oxygen concentration can be measured by detecting the light intensity of output light 13.

In the principle drawings shown in FIGS. 1 and 2, the light intensity of output light 13 is reduced not only by the absorption of part of excitation light 11 or emitted light 12 by the light-absorbing layer 4 bonded with oxygen molecules, but also by the oxygen quenching characteristics of the light-emitting layer 3 as such, so it is possible to induce greater variations in the light intensity of emitted light versus variations in the oxygen concentration, and to enhance the oxygen sensitivity by synergizing the two effects.

In the present invention, selecting the dye molecule 7 that can be used for the light-absorbing layer 4 is important, but, for the other elements such as the luminescent molecules in the light-emitting layer, excitation techniques, and measurement techniques, the elements used in prior art methods can be used. Specifically, platinum octaethyl porphyrin, platinum tetrakispentafluorophenyl porphyrin, or another metal porphyrin complex; Bathophenanthroline ruthenium chloride or another transition metal complex; or pyrene, perylene, or another polycyclic aromatic compound or derivative thereof may be used as the luminescent molecule. In addition, a xenon lamp, halogen lamp, laser, light-emitting diode, or other light source that matches the absorption spectrum of the luminescent molecule can be used as an excitation light source. For measurements, it is possible to use solid-state image sensors typified by CCD sensors in addition to photomultipliers, avalanche photodiodes, and other optical sensors.

The oxygen concentration measurement principle of the present invention can be applied to measuring the oxygen concentration of a vapor phase, a liquid including blood, an interior of a biological tissue, or a skin. The principle can also be used as a means for measuring air pressure because the oxygen concentration of air varies in accordance with pressure variations. These applications can be implemented not only as solid structures obtained by solidifying and laminating luminescent molecule layers, but also as film structures obtained by applying and drying materials, in the form of a paint dissolved in a solvent, with the aid of a brush, air brush, or the like on a body serving as a measurement object.

Embodiments

The principle of the optical oxygen concentration measurement method according to the present invention will now be described using a solution system as an example. The cobalt picket-fence porphyrin complex (designated as “CoP” hereinbelow) shown in FIG. 3 is used herein as the dye molecule for the light-absorbing layer in order to allow the absorption spectrum to be varied by the bonding with oxygen molecules. The center wavelength of the absorption band (Soret band) of the absorption spectrum inherent in CoP is moved from 418 nm to 440 nm by the bonding of oxygen. The movement proceeds reversibly in accordance with variations in the oxygen concentration or air pressure. In this case, a complex comprising CoP and 1-benzylimadazole is used as the light-absorbing dye molecule, a pyrene-1-butylic acid with an excimer emission peak at 480 nm is used as the light-emitting dye molecule, where part of the emission of the pyrene-1-butylic acid is absorbed by CoP.

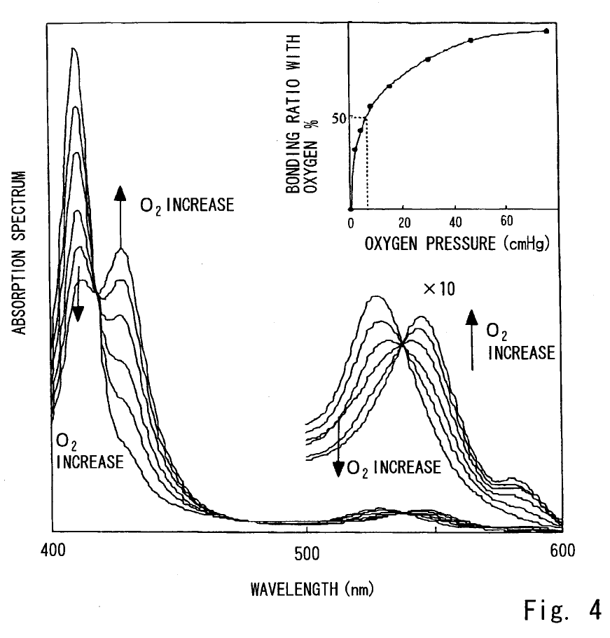

FIG. 4 is a diagram depicting spectroscopic properties that correspond to the bonding with oxygen molecules for the CoP used for the light-absorbing layer 4. The horizontal axis indicates wavelength (nm) and the vertical axis indicates the light absorption spectrum. With an increase in the oxygen partial pressure, the absorption peak at a wavelength of about 410 nm decreases, the peak increases in the vicinity of 430 nm, and the peak at about 530 nm (shown by a tenfold magnification of the horizontal axis) decreases and the peak at about 540 nm increases. If the emphasis is placed on the peaks in the vicinity of 410 nm and 430 nm wavelengths, the waveform of the light absorption spectrum varies with increased oxygen partial pressure and enhanced bonding with oxygen molecules, and this variation can be regarded as being the same as that occurring during a shift to longer wavelengths when viewed in terms of a relation with the wavelength. The upper right part of FIG. 4 is a drawing depicting the bonding rate with oxygen molecules (vertical axis) versus oxygen partial pressure (horizontal axis), and because the degree of bonding with oxygen molecules undergoes a rapid variation in the region of low oxygen pressures, it is possible to expect that high detection sensitivity will be achieved in the region of low oxygen pressures.

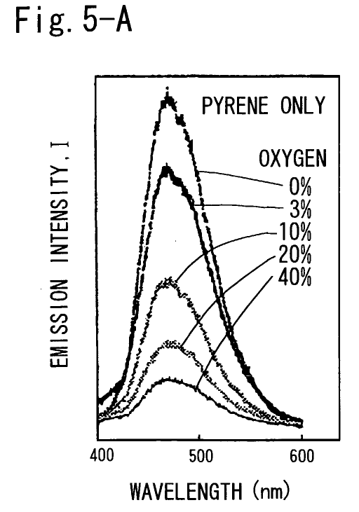

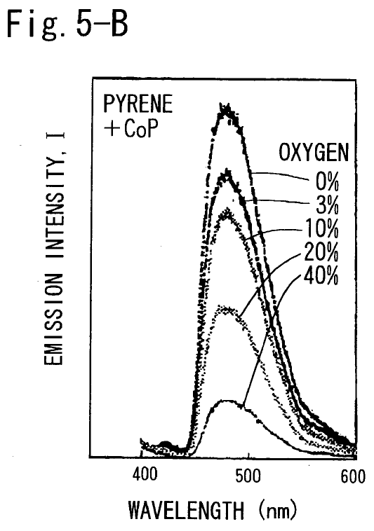

FIG. 5 depicts the results of measured light emission spectra in solution systems into which the above-described two molecules have been mixed together. FIG. 5-A depicts the light emission spectrum of pyrene-1-butylic acid (light-emitting dye molecule) only, and FIG. 5-B depicts a light emission spectrum obtained by adding CoP (light-absorbing dye molecule). In the particular case of the solution system shown in FIG. 5-B, 32 mg of perene, 0.55 mg of cobalt picket-fence porphyrin (CoP), and 5 mg of 1-benzylimadazole were dissolved in 50 mL of distilled dichloromethane. This solution was introduced into a quartz cell of 1 cm×1 cm×4 cm, the cell was sealed with septum rubber, and oxygen/nitrogen gas mixtures with different oxygen partial pressures (0%, 3%, 10%, 20%, and 40%) were blown into the solution for 10 to 15 minutes. Luminescent light intensity at each of the oxygen partial pressures was measured with a spectrofluorometer. It can be seen that the emission intensity (vertical axis (I)) decreases accordingly as the oxygen concentration varies from 0% to 40%. It can further be seen in FIG. 5-B that when CoP was added, the shorter wavelength side of the light emission spectrum of pyrene-1-butylic acid was cut off and the emission intensity (I) was reduced by the CoP bonded with oxygen.

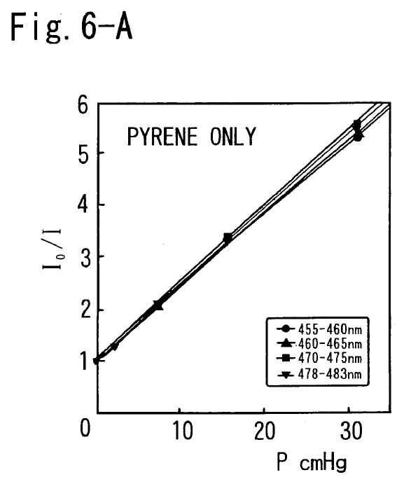

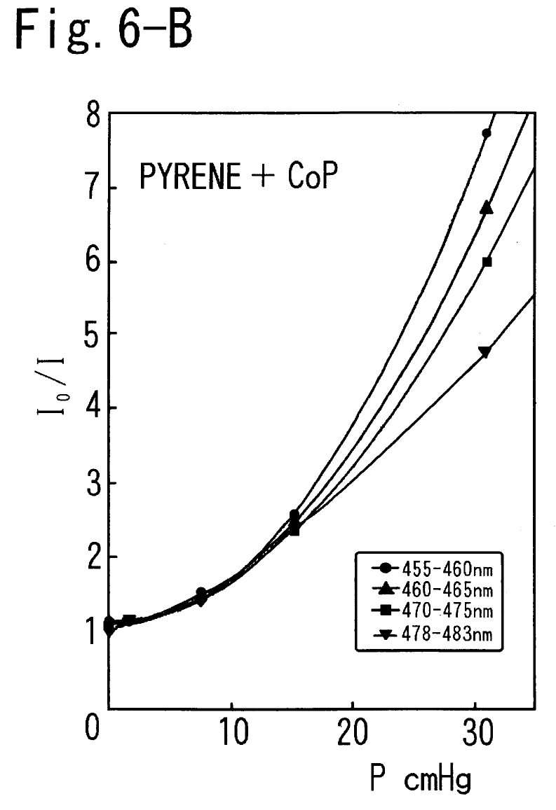

FIG. 6 is a diagram in which variations in the emission intensity of a solution system versus oxygen concentration are plotted in a Stern-Volmer format for various observed wavelength bands. The horizontal axis indicates oxygen partial pressure, and the vertical axis indicates the ratio of the emission intensity I at an arbitrary oxygen partial pressure to the emission intensity I₀ at an oxygen partial pressure of 0 cm Hg as a reciprocal number (I₀/I). When pyrene only is used as the luminescent molecule, the sensitivity curve assumes a linear shape such as the one given by the theory, and no dependence on the observed wavelength can be found, as shown in FIG. 6-A. When, however, CoP is added as a light-absorbing molecule, the slope of the sensitivity curve increases in the region of high oxygen pressures, nonlinearity becomes apparent, and the existence of a sensitization effect based on a CoP film can thereby be confirmed, as shown in FIG. 6-B. The sensitization effect based on the absorption dye molecule becomes more pronounced when the observed wavelength is close to the wavelength at which the absorption spectrum of CoP is present. For example, sensitivity for oxygen has been increased about 70% for an oxygen concentration of 30 cm Hg in the observed wavelength region of 455 to 460 nm. The oxygen concentration band in which the sensitization effect appears can be varied by changing the ligand of the complex and controlling the affinity for oxygen.

Following is a description of an embodiment in which a light-absorbing layer and a light-emitting layer are formed as a film on a substrate. Pyrene-1-butylic acid is used herein as the luminescent molecule in the same manner as in the above embodiment, and a product obtained by adsorbing this on an anodized aluminum substrate is fashioned into a light-emitting layer. Furthermore, CoP was used as the dye molecule for the light-absorbing layer in the same manner as in the above-described example, and a complex comprising this molecule and poly(vinylidene chloride-co-vinyl imidazole) (“CIm” hereinbelow) was fashioned into a light-absorbing layer. The concentration of CoP, expressed as percent by weight, was 5%. The light-absorbing layer was overlaid on the light-emitting layer by applying a chloroform solution of CoP and CIm with an air brush. Specifically, 5 mg of CoP and 100 mg of CIm (molecular weight: 100,000; vinyl imidazole content: 12%) were dissolved in 10 mL of distilled chloroform, a CoP-CIm complex was allowed to form, and a starting solution for an absorption film was obtained. This solution was applied (twice each in the longitudinal and transverse directions) by an air brush to a pyrene-1-butylic acid /anodized aluminum (PBA/AA) film, and light emission was measured using a spectrofluorometer at each oxygen partial pressure.

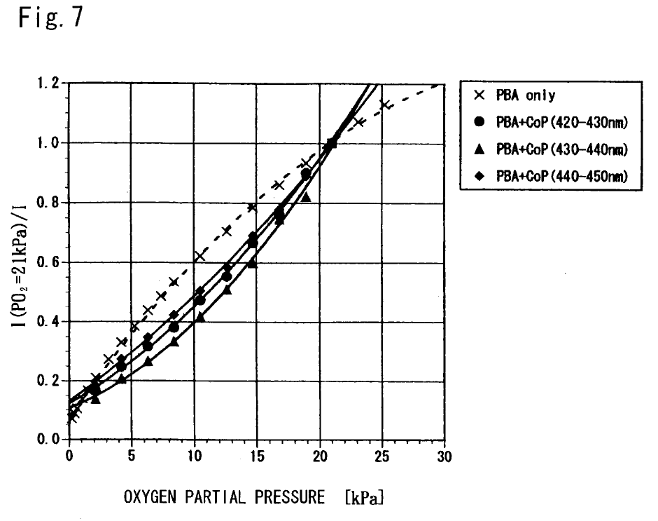

FIG. 7 is a diagram in which variations in the emission intensity of a CoP-CIm/pyrene-1-butylic acid bilayer film versus oxygen concentration are plotted in a Stern-Volmer format for various observed wavelength bands. The horizontal axis indicates oxygen partial pressure, and the vertical axis indicates the ratio of the emission intensity I at an arbitrary oxygen partial pressure to the emission intensity I (PO₂₌₂₁ kPa) at an oxygen partial pressure PO₂ of 21 kPa (corresponds to the oxygen partial pressure in the case of the atmosphere) as a reciprocal number. In the same manner as with a solution system, the sensitivity curve assumes a linear shape such as the one given by the theory, and no dependence on the observed wavelength can be found when pyrene only is used as the luminescent molecule, but nonlinearity becomes apparent when CoP is added as a light-absorbing dye molecule, as shown in FIG. 7. The slope of the sensitivity curve increases in the region of high oxygen partial pressures, and the existence of a sensitization effect based on a CoP film can thereby be confirmed.

In addition to the above examples, cobalt Schiff base complexes, and typically ethylene bis(salicylideneiminate)cobalt complexes, can be cited as examples of dye molecules that can be used in the light-absorbing layer. Such poly(vinylpyridine) complexes can reversibly change their color from pale walnut (absorption band: 345 nm) in the absence of oxygen to blackish brown (555 nm) in the presence of oxygen. Methylene Blue and other dye molecules whose absorption spectrum is varied by a redox reaction with oxygen can satisfy the object of the present application in addition to the dye molecules whose absorption spectrum is varied by bonding with oxygen molecules.

The present invention was described above with reference to embodiments, but oxygen concentration measurements of a type that exhibits a nonlinearity model with an increased intensity at high oxygen concentrations can also be implemented when the overlap between the excitation spectrum or light emission spectrum of a light-emitting molecule and the absorption spectrum of a light-absorbing molecule occurs at a longer wavelength and the overlap between the two spectra decreases with increased oxygen concentration. In addition, the combination of a light-emitting layer and a light-absorbing layer is not limited to the laminated film structure in which the layers are overlaid on a substrate, as shown in FIG. 1, and can also be fashioned into a structure in which a layer is separately formed on each of the glass or film surfaces. In addition, the output light, instead of being retrieved in the form of reflected light produced by incident light such as that shown in FIG. 1, can also be retrieved as transmitted light that has passed through the light-emitting layer and light-absorbing layer. Furthermore, even when the light-emitting layer does not have any reactive properties in relation to oxygen, such as oxygen quenching characteristics, the oxygen concentration can still be measured based on the variations in the absorption spectrum of the light-absorbing layer brought about by the bonding of the light-absorbing dye molecules with oxygen molecules.

As described above, the optical oxygen concentration measurement method and optical oxygen concentration measuring sensor according to the present invention can provide a novel method and sensor for measuring an oxygen concentration by combining a light-emitting layer and a light-absorbing layer whose absorption spectrum varies depending on bonding with oxygen molecules. In addition, oxygen sensitivity can be improved over that of a conventional optical oxygen sensor based solely on oxygen quenching by combining a light-absorbing layer and a light-emitting layer comprising a dye molecule that has oxygen quenching characteristics. This will make it possible to construct an optical oxygen sensor with high sensitivity at high partial oxygen pressures. The measurement method and sensor according to the present invention can also be used for high-sensitivity pressure measurements in wind tunnel tests and other aerodynamic experiments involving the use of air or gas containing oxygen, in the form of optical fiber sensors as well as film structures obtained by applying and drying materials, in the form of a paint dissolved in a solvent, with the aid of a brush, air brush, or the like on a body serving as a measurement object.

What is claimed is:

1. An optical oxygen concentration measurement method, comprising:
using a combination of a light-emitting layer for receiving excitation light and emitting light, and a light-absorbing layer whose light absorption spectrum varies depending on the degree of bonding with oxygen molecules, which varies in accordance with the oxygen concentration; and
measuring the oxygen concentration by detecting the light intensity of output light that varies based on the partial absorption of light emitted by the light-emitting layer or incident light for initiating light emission in the light-emitting layer during passage through the light-absorbing layer.

2. The optical oxygen concentration measurement method according to claim 1, wherein the light partially absorbed by the light-absorbing layer is the incident light for initiating light emission in the light-emitting layer;
the output light is light that is emitted by the light-emitting layer; and
the overlap of the excitation spectrum of the light-emitting layer and the light absorption spectrum varies in accordance with variations in the light absorption spectrum.

3. The optical oxygen concentration measurement method according to claim 1, wherein the light partially absorbed by the light-absorbing layer is the light that is emitted by the light-emitting layer;
the output light is light emitted by the light-emitting layer that is transmitted through the light-absorbing layer; and
the overlap of the light emission spectrum of the light-emitting layer and the light absorption spectrum varies in accordance with variations in the light absorption spectrum.

4. The optical oxygen concentration measurement method according to claim 1, wherein the light-emitting layer is a light-emitting dye-molecule layer in which the light intensity of the emitted light is caused to vary by a reaction with oxygen molecules, which varies in accordance with the oxygen concentration.

5. The optical oxygen concentration measurement method according to claim 1, wherein the light-absorbing layer is a layer that comprises a cobalt-porphyrin complex as the light-absorbing dye molecule.

6. The optical oxygen concentration measurement method according to claim 1, which is applied to measure the oxygen concentration of a gas or liquid that comprises the oxygen molecules, or the pressure of a gas that comprises the oxygen molecules.

7. An optical oxygen concentration measuring sensor, comprising:
a light-emitting layer for receiving excitation light and emitting light; and
a light-absorbing layer whose light absorption spectrum varies depending on the degree of bonding with oxygen molecules, which itself varies in accordance with the oxygen concentration,
wherein variations are created in the light intensity of output light on the basis of partial absorption when light emitted by the light-emitting layer, or incident light for initiating light emission in the light-emitting layer, passes through the light-absorbing layer.

8. The optical oxygen concentration measuring sensor according to claim 7, wherein the light partially absorbed by the light-absorbing layer is the incident light for initiating light emission in the light-emitting layer;
the output light is light that is emitted by the light-emitting layer; and
the overlap of the excitation spectrum of the light-emitting layer and the light absorption spectrum varies in accordance with variations in the light absorption spectrum.

9. The optical oxygen concentration measuring sensor according to claim 7, wherein the light partially absorbed by the light-absorbing layer is the light that is emitted by the light-emitting layer;
the output light is light emitted by the light-emitting layer that is transmitted through the light-absorbing layer; and
the overlap of the light emission spectrum of the light-emitting layer and the light absorption spectrum varies in accordance with variations in the light absorption spectrum.

10. The optical oxygen concentration measuring sensor according to claim 7, wherein the light-emitting layer is a light-emitting dye-molecule layer in which the light intensity of the emitted light is caused to vary by a reaction with oxygen molecules, which varies in accordance with the oxygen concentration.

11. The optical oxygen concentration measuring sensor according to claim 7, wherein the light-absorbing layer is a layer that comprises a cobalt-porphyrin complex as the light-absorbing dye molecule.

12. The optical oxygen concentration measuring sensor according to claim 7, which is applied to measure the oxygen concentration of a gas or liquid that comprises the oxygen molecules, or the pressure of a gas that comprises the oxygen molecules.
